(19) United States
(12) Patent Application Publication
(10) Pub. No.: US 2010/0031034 A1
(43) Pub. Date: Feb. 4, 2010

(54) METHOD AND APPARATUS FOR PROTECTING FILE IN DIRECT PRINTING

(75) Inventor: Jin KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/465,265

(22) Filed: May 13, 2009

(30) Foreign Application Priority Data
Jul. 29, 2008 (KR) 10-2008-0074091

(51) Int. Cl. H04L 9/00

(52) U.S. Cl. 713/165; 380/45; 380/51

(57) ABSTRACT

Provided are a method and apparatus for protecting files to be directly printed. The method includes transmitting an encryption key, when an encrypted file is received, receiving a password of the file encrypted using the encryption key, decrypting the password using a decryption key corresponding to the encryption key, and decrypting the encrypted file using the decrypted password. Accordingly, in performing direct printing, the transmitted file can be protected by encryption. Also, since the password of the file is encrypted and decrypted, the password is not required to be directly input to the printing device and other printing devices can be safely used along with the printing device to which the password is input, thereby increasing convenience for user input.

### CROSS-REFERENCE TO RELATED PATENT APPLICATION

This application claims priority from Korean Patent Application No. 10-2008-0074091, filed on Jul. 29, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to protecting files such as document files and image files which are to be directly printed, and more particularly, to encrypting and decrypting a password of an encrypted document file or image file which is to be printed.

2. Description of the Related Art

Direct printing comprises transmitting a file to be printed directly to a printing device from a device storing the file and directly performing a printing task without depending on printing relay devices such as a computer. In other words, a document to be printed is not converted into a language of a printing device and instead, the document itself is transmitted to a printing device so as to be printed.

FIG. 1 illustrates conventional direct printing. Referring to FIG. 1, when a predetermined document is to be directly printed from a personal computer (PC) 110, the document file is directly transmitted to a printing device 130 without using a printer driver. Then, the printing device 130 directly prints the document. Currently, digital photographing devices such as digital cameras, digital camcorders, and mobile phones including functions of a digital camera are widely used. Referring to FIG. 1 again, a user of a digital camera 120 transmits image files stored in the digital camera 120 directly to the printing device 130, instead of transmitting the image files via a delay device such as the PC 110, and the images are printed.

In direct printing, time needed for printing can be saved and load of a PC can be reduced. However, while performing direct printing, a method of protecting documents or images that are transmitted to a printing device does not exist. In addition, when a method of encrypting the document itself is applied to the transmitted document, a password should be directly input to a printing device and only a printing device to which the password is input can be used.

### SUMMARY OF THE INVENTION

The present invention provides a method and apparatus for protecting files such as document files and image files which are to be directly printed by encrypting and decrypting passwords of the document files and the image files.

The present invention also provides a method and apparatus for protecting a file linked to a file to be printed by encrypting and decrypting the linked file.

According to an aspect of the present invention, there is provided a method of protecting a file to be directly printed, the method including: receiving an encryption key from an external device, when an encrypted file is transmitted to the external device; encrypting a password of the encrypted file using the received encryption key; and transmitting the encrypted password to the external device.

The encryption key may be a public key.

The file may be encrypted using a symmetric key.

According to another aspect of the present invention, there is provided a method of protecting a file to be directly printed, the method including: transmitting an encryption key to an external device, when an encrypted file is received from the external device; receiving a password of the file encrypted using the encryption key from the external device; decrypting the password using a decryption key corresponding to the encryption key; and decrypting the encrypted file using the decrypted password.

The method may further include generating the encryption key and the decryption key.

The encryption key may be a public key and the decryption key may be a private key.

The public key and the private key may be used only once.

The file may be encrypted using a symmetric key.

According to another aspect of the present invention, there is provided a method of protecting a first file to be directly printed, the method including: requesting, when a second file to which the first file is linked is received from an external device, a device in which the first linked file exists for the first linked file; transmitting an encryption key to the device in which the first linked file exists; receiving the first linked file encrypted using the encryption key from the device in which the first linked file exists; and decrypting the encrypted first linked file using a decryption key corresponding to the encryption key.

The method may further include directly printing file data of the first file based on the decrypted encrypted first linked file.

The method may further include generating the encryption key and the decryption key.

The encryption key may be a public key and the decryption key may be a private key.

The public key and the private key may be used only once.

According to another aspect of the present invention, there is provided an apparatus for protecting a file to be directly printed, the apparatus including: an interface unit which receives an encryption key from an external device, when an encrypted file is transmitted to the external device; and an encryption unit which encrypts a password of the encrypted file using the received encryption key, wherein the interface unit transmits the encrypted password to the external device.

According to another aspect of the present invention, there is provided apparatus for protecting a file to be directly printed, the apparatus including: an interface unit which transmits an encryption key to an external device, when an encrypted file is received from the external device, and receives a password of the file encrypted using the encryption key from the external device; and an decryption unit which decrypts the password using a decryption key corresponding to the encryption key and decrypts the encrypted file using the decrypted password.

According to another aspect of the present invention, there is provided an apparatus for protecting a first file to be directly printed, the apparatus including: an interface unit, when a second file to which the first file is linked is received from an external device, which requests the external device in which the first linked file exists for the first linked file and transmits an encryption key to the external device in which the first linked file exists; and an decryption unit, when the first linked file encrypted using the encryption key is received from the external device in which the first linked file exists, which decrypts the encrypted first linked file using a decryption key corresponding to the encryption key.

### BRIEF DESCRIPTION OF THE DRAWINGS

The above and other features and aspects of the present invention will become more apparent by describing in detail exemplary embodiments thereof with reference to the attached drawings in which:

FIG. 1 illustrates conventional direct printing;

FIG. 2 is a block diagram of a direct printing system according to an embodiment of the present invention;

FIG. 3 is a flowchart illustrating an encryption method applied to a file in a method of directly printing a file, according to an exemplary embodiment of the present invention;

FIG. 4 is a flowchart illustrating a decryption method applied to a file in a method of directly printing a file, according to an exemplary embodiment of the present invention; and

FIG. 5 is a flowchart illustrating an encryption method and a decryption method applied to a file linked to a file in a method of directly printing a file, according to an exemplary embodiment of the present invention.

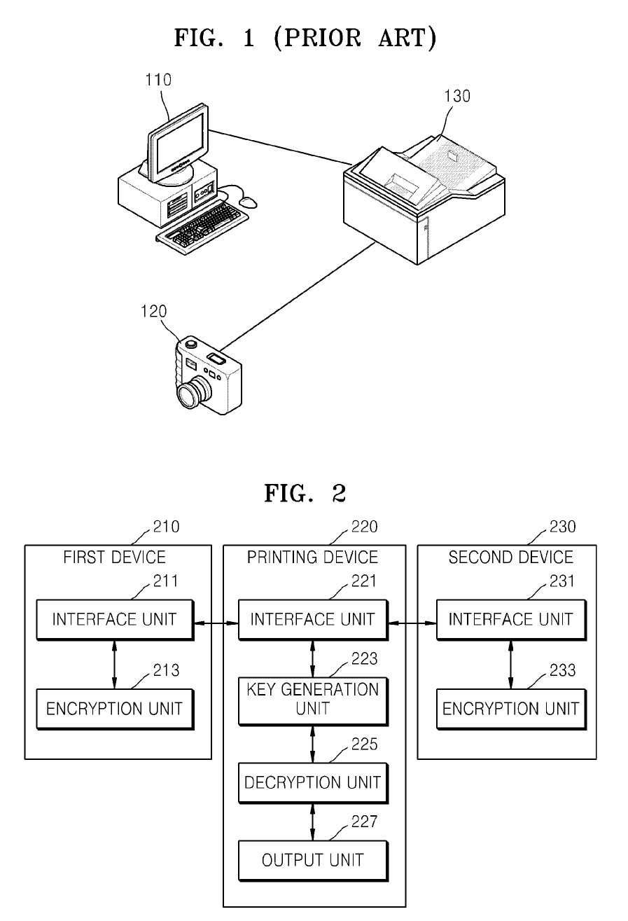

### DETAILED DESCRIPTION OF THE EXEMPLARY EMBODIMENTS OF THE INVENTION

In embodiments of the present invention, file data is denoted as data of document files or image files which are directly transmitted to a printing device while performing direct printing. In this case, the printing device directly prints file data of the document files or the image files. Examples of the document files or the image files include PDF, JPEG, HTML, TIFF, GIF, and BMP files. However, the document files or the image files are not limited thereto and may be any file data which can be directly printed.

Hereinafter, the present invention will be described in detail with reference to the accompanying drawings, in which exemplary embodiments of the invention are shown.

FIG. 2 is a block diagram of a direct printing system according to an embodiment of the present invention.

Referring to FIG. 2, the direct printing system according to the current embodiment of the present invention includes a first device 210, a printing device 220, and a second device 230, wherein the first device 210 includes an interface unit 211 and an encryption unit 213, the printing device 220 includes an interface unit 221, a key generation unit 223, a decryption unit 225, and an output unit 227, and the second device 230 includes an interface unit 231 and an encryption unit 233.

The first device 210 is connected to the printing device 220 through a predetermined wire or a general-purpose wireless interface. Examples of the general-purpose wireless interface include USB, IEEE1394, Bluetooth, Wireless USB, and WIFI. The first device 210 transmits files, for example, PDF files or image files, to the printing device 220 for direct printing. Examples of the first device 210 include a computer, a digital camera, a mobile phone, a Personal Digital Assistant (PDA), and a portable storage medium such as USB. However, it is obvious to one of ordinary skill in the art to which the present invention pertains that the first device 210 is not limited to the examples above and may be any device which provides document files or image files to the printing device 220. In addition, it is obvious to one of ordinary skill in the art to which the present invention pertains that the general-purpose interface is not limited to the examples above and may be other kinds of general-purpose wire or wireless interface.

The interface unit 211 included in the first device 210 transmits a file to be directly printed to the printing device 220. In the current embodiment, the file transmitted to the printing device 220 is denoted as an encrypted file. For example, in the case of a PDF file, a password is input to the document file itself and the document file is encrypted. According to another embodiment of the present invention, the encryption unit 213 included in the first device 210 may encrypt the password of the encrypted file. More preferably, the password of the encrypted file may be encrypted using a symmetric key. In using a symmetric key, the same encryption key and decryption key are used. The symmetric key is used in data encryption from a transmitter side, when data is transmitted, and the same symmetric key is used in data encryption from a receiver side, when transmission is completed.

The interface unit 221 included in the printing device 220 is connected to the first device 210 and the second device 230 and controls data input and output to the first device 210 and the second device 230.

When the encrypted file is transmitted from the first device 210 to the printing device 220, the key generation unit 223 generates an encryption key for the file and a decryption key corresponding to the encryption key. According to the current embodiment of the present invention, the encryption key is a public key and a decryption key is a private key based on asymmetric encryption. The public key and private key may be used only once for direct printing.

The interface unit 221 included in the printing device 220 transmits the encryption key generated in the key generation unit 223 to the interface unit 211 included in the first device 210. The encryption unit 213 included in the first device 210 encrypts a password for encrypting the file itself using the received encryption key. Also, when the file is encrypted by the symmetric key, the encryption unit 213 included in the first device 210 encrypts a password of the symmetric key and a symmetric key algorithm. The password may be encrypted using the received public key. The interface unit 211 included in the first device 210 transmits the password of the encrypted file to the interface unit 221 included in the printing device 220.

The decryption unit 225 decrypts the encrypted password using the decryption key which corresponds to the generated encryption key. When the password is encrypted by the public key, the encrypted password is decrypted using the private key. Then, the encrypted file is decrypted using the decrypted password. When the file is encrypted by the symmetric key, the file is decrypted using the decrypted symmetric key and symmetric key algorithm.

The output unit 227 directly prints a file of the decrypted file.

According to another exemplary embodiment of the present invention, a predetermined file may be linked to file data of the file transmitted from the first device 210. In this case, the printing device 220 acquires the linked file from another device and directly prints the file data using the acquired file.

When the interface unit 221 included in the printing device 220 receives from the first device 210 the file to which a predetermined file is linked, the interface unit 221 requests the second device 230, that is, the device in which the linked file exists, for the linked file. The printing device 220 and the second device 230 are connected to each other through a predetermined wire or wireless communication network.

When the printing device 220 requests the second device 230 for the linked file, the key generation unit 223 generates the encryption key for the linked file and the decryption key corresponding to the encryption key. The encryption key may be a public key and a decryption key may be a private key based on asymmetric encryption. Also, the public key and private key may be used only once for direct printing.

The interface unit 221 included in the printing device 220 transmits the encryption key generated with the request of the linked file to the interface unit 231 included in the second device 230.

The encryption unit 233 included in the second device 230 encrypts the requested linked file using the transmitted encryption key. Here, when the public key is transmitted, the requested linked file is encrypted using the public key. Then, the interface unit 231 included in the second device 230 transmits the encrypted linked file to the printing device 220.

The interface unit 221 included in the printing device 220 receives the linked file encrypted by the encryption key from the second device 230.

The decryption unit 225 decrypts the encrypted linked file using the generated decryption key. When the linked file is encrypted by the public key, the linked file is decrypted by the private key.

The output unit 227 directly prints the file data using the decrypted linked file.

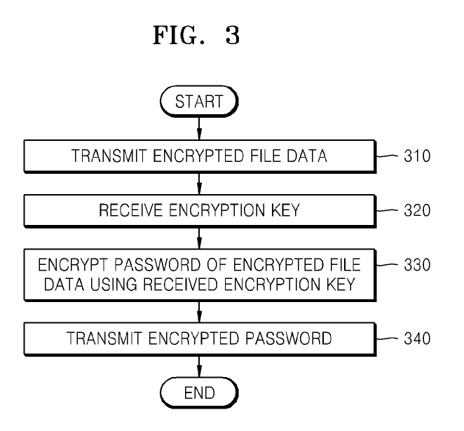

FIG. 3 is a flowchart illustrating an encryption method applied to a file in a method of directly printing a file, according to an exemplary embodiment of the present invention.

Referring to FIG. 3, in operation 310, the first device 210 transmits an encrypted file to the printing device 220 which performs direct printing. The file may be encrypted by inputting a password to the file itself. According to another exemplary embodiment, the password of the transmitted encrypted file may be encrypted, for example, by a symmetric key.

In operation 320, an encryption key is received from the printing device 220. The encryption key may be a public key.

In operation 330, the password of the encrypted file data is encrypted using the received encryption key. When the file is encrypted by the symmetric key, the symmetric key password and the symmetric key algorithm are encrypted using the received encryption key.

In operation 340, the encrypted password and symmetric key algorithm are transmitted to the printing device 220.

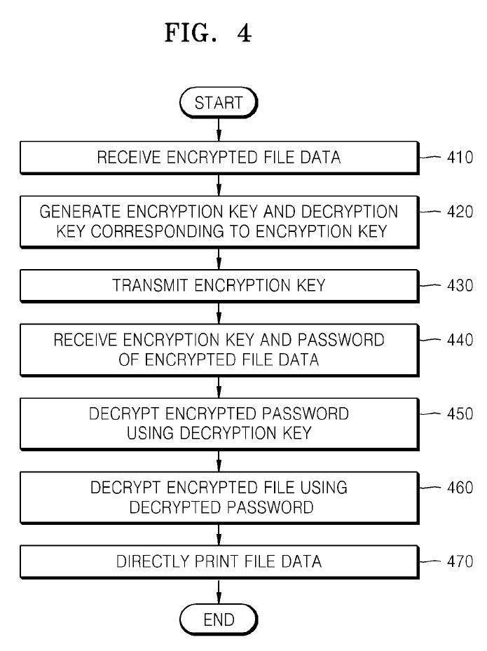

FIG. 4 is a flowchart illustrating a decryption method applied to a file in a method of directly printing a file, according to an exemplary embodiment of the present invention.

Referring to FIG. 4, in operation 410, an encrypted file is received from the first device 210.

In operation 420, the printing device 220 generates an encryption key and a decryption key corresponding to the encryption key. More preferably, the encryption key may be a public key and the decryption key may be a private key.

In operation 430, the generated encryption key, more preferably, the public key is transmitted to the first device 210.

In operation 440, the first device 210 receives the password of the file encrypted using the encryption key.

In operation 450, the encrypted password is decrypted using the decryption key. When the password is encrypted by the public key, the encrypted password is decrypted using the private key.

In operation 460, the encrypted file is decrypted using the decrypted password. When the file is encrypted by the symmetric key, the encrypted file is decrypted using the symmetric key password.

In operation 470, the file data of the decrypted file is directly printed.

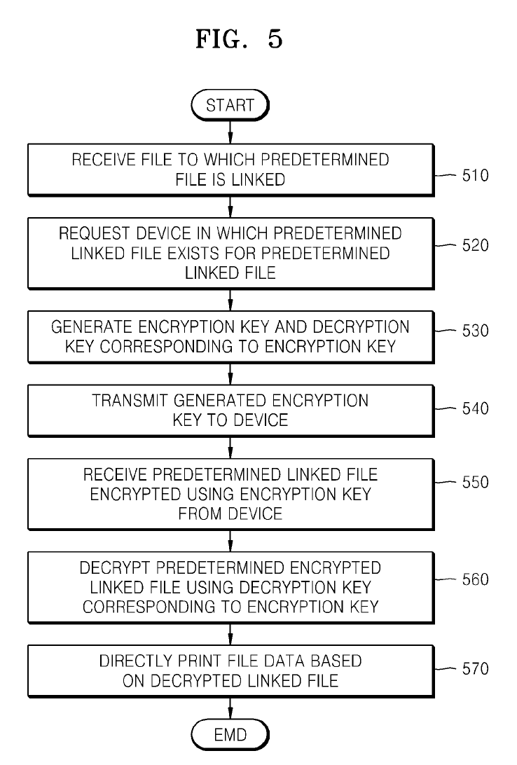

FIG. 5 is a flowchart illustrating an encryption method and a decryption method applied to a file linked to a file in a method of directly printing a file, according to an embodiment of the present invention.

In some cases, a predetermined file is linked to file data of a file transmitted from the first device 210. In this case, the printing device 220 acquires the linked file from another device and directly prints the file data using the acquired file.

Referring to FIG. 5, in operation 510, the file, to which a predetermined file is linked, is received.

In operation 520, the linked file is requested from the device in which the predetermined linked file exists.

In operation 530, when the linked file is requested from the device in which the linked file exists, an encryption key for the linked file and a decryption key corresponding to the encryption key are generated. The encryption key may be a public key and a decryption key may be a private key based on asymmetric encryption. Also, the public key and private key may be a single-use for direct printing.

In operation 540, the generated encryption key is transmitted to the device in which the linked file exists. More preferably, the linked file is requested and the encryption key is distributed to the device in which the linked file exists at the same time.

In operation 550, the predetermined linked file encrypted using the encryption key is received from the device in which the linked file exists. When the encryption key is transmitted, the device, in which the linked file exists, encrypts the requested linked file using the encryption key. When the public key is transmitted, the requested linked file is encrypted using the public key.

In operation 560, the predetermined encrypted linked file is decrypted using the decryption key which corresponds to the encryption key. When the linked file is encrypted using the public key, the encrypted linked file is decrypted using the private key.

In operation 570, the file data is directly printed based on the decrypted linked file.

According to the present invention, in performing direct printing, the transmitted file can be protected by encryption. In addition, since the password of the file is encrypted and decrypted, the password is not required to be directly input to the printing device and other printing devices can be safely used along with the printing device to which the password is input, thereby increasing convenience for user input.

The invention can also be embodied as computer readable program on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of protecting a file to be directly printed, the method comprising:
receiving an encryption key from an external device, when an encrypted file is transmitted to the external device;
encrypting a password of the encrypted file using the received encryption key; and
transmitting the encrypted password to the external device.

2. The method of claim 1, wherein the encryption key is a public key.

3. The method of claim 1, wherein the file is encrypted using a symmetric key.

4. A method of protecting a file to be directly printed, the method comprising:
transmitting an encryption key to an external device, when an encrypted file is received from the external device;
receiving a password of the file encrypted using the encryption key from the external device;
decrypting the password using a decryption key corresponding to the encryption key; and
decrypting the encrypted file using the decrypted password.

5. The method of claim 4, further comprising generating the encryption key and the decryption key.

6. The method of claim 5, wherein the encryption key is a public key and the decryption key is a private key.

7. The method of claim 6, wherein the public key and the private key are used only once.

8. The method of claim 6, wherein the file is encrypted using a symmetric key.

9. A method of protecting a first file to be directly printed, the method comprising:
requesting, when a second file to which the first file is linked is received from an external device, a device in which the first linked file exists for the first linked file;
transmitting an encryption key to the device in which the first linked file exists;
receiving the first linked file encrypted using the encryption key from the device in which the first linked file exists; and
decrypting the encrypted first linked file using a decryption key corresponding to the encryption key.

10. The method of claim 9, further comprising directly printing file data of the first file based on the decrypted encrypted first linked file.

11. The method of claim 9, further comprising generating the encryption key and the decryption key.

12. The method of claim 11, wherein the encryption key is a public key and the decryption key is a private key.

13. The method of claim 12, wherein the public key and the private key are used only once.

14. An apparatus for protecting a file to be directly printed, the apparatus comprising:
an interface unit which receives an encryption key from an external device, when an encrypted file is transmitted to the external device; and
an encryption unit which encrypts a password of the encrypted file using the received encryption key,
wherein the interface unit transmits the encrypted password to the external device.

15. The apparatus of claim 14, wherein the encryption key is a public key.

16. The apparatus of claim 14, wherein the file is encrypted using a symmetric key.

17. An apparatus for protecting a file to be directly printed, the apparatus comprising:
an interface unit which transmits an encryption key to an external device, when an encrypted file is received from the external device, and receives a password of the file encrypted using the encryption key from the external device; and
a decryption unit which decrypts the password using a decryption key corresponding to the encryption key and decrypts the encrypted file using the decrypted password.

18. The apparatus of claim 17, further comprising a key generation unit which generates the encryption key and the decryption key.

19. The apparatus of claim 18, wherein the encryption key is a public key and the decryption key is a private key.

20. The apparatus of claim 19, wherein the public key and the private key are used only once.

21. The apparatus of claim 17, wherein the file is encrypted using a symmetric key.

22. An apparatus for protecting a first file to be directly printed, the apparatus comprising:
an interface unit, when a second file to which the first file is linked is received from an external device, which requests the external device in which the first linked file exists for the first linked file and transmits an encryption key to the external device in which the first linked file exists; and
a decryption unit, when the first linked file encrypted using the encryption key is received from the external device in which the first linked file exists, which decrypts the encrypted first linked file using a decryption key corresponding to the encryption key.

23. The apparatus of claim 22, further comprising an output unit which directly prints file data of the first file based on the decrypted encrypted first linked file.

24. The apparatus of claim 22, further comprising a key generation unit which generates the encryption key and the decryption key.

25. The apparatus of claim 24, wherein the encryption key is a public key and the decryption key is a private key.

26. A computer readable recording medium having embodied thereon a computer program for executing a method of protecting a file to be directly printed, the method comprising:
receiving an encryption key from an external device, when an encrypted file is transmitted to the external device;
encrypting a password of the encrypted file using the received encryption key; and
transmitting the encrypted password to the external device.

27. A computer readable recording medium having embodied thereon a computer program for executing a method of protecting a file to be directly printed, the method comprising:
transmitting an encryption key to an external device, when an encrypted file is received from the external device;
receiving a password of the file encrypted using the encryption key from the external device;
decrypting the password using a decryption key corresponding to the encryption key; and
decrypting the encrypted file using the decrypted password.

28. A computer readable recording medium having embodied thereon a computer program for executing a method of protecting a first file to be directly printed, the method comprising:
requesting, when a second file to which the first file is linked is received from an external device, a device in which the first linked file exists for the first linked file;
transmitting an encryption key to the device in which the first linked file exists;
receiving the first linked file encrypted using the encryption key from the device in which the first linked file exists; and
decrypting the encrypted first linked file using a decryption key corresponding to the encryption key.
